(19) United States
(12) Patent Application Publication
(10) Pub. No.: US 2012/0215613 A1
(43) Pub. Date: Aug. 23, 2012

(54) SYSTEM AND METHOD FOR MANAGING OFFERS FOR PREPAID TELEPHONY ACCOUNTS

(76) Inventors: Rajiv Madhok, New Delhi (IN); Deepak Mittal, Delhi (IN)

(21) Appl. No.: 13/346,639

(22) Filed: Jan. 9, 2012

(30) Foreign Application Priority Data
Feb. 22, 2011 (IN) 470/DEL/2011

(51) Int. Cl. G06Q 30/02

(52) U.S. Cl. 705/14.25

(57) ABSTRACT

A method for managing offers for prepaid telephony accounts of a plurality of users is provided. The method includes obtaining information related to user profiles and usage patterns of a plurality of telecommunication services offered to the plurality of users through their respective prepaid telephony accounts. The method also includes customizing prepaid telephony offers for each of the plurality of users based upon the information related to the user profiles and the usage patterns and delivering the customized prepaid telephony offers to a mobile device of each of the plurality of users via unstructured supplementary services data (USSD) messages.

### BACKGROUND

The invention relates generally to a system and method for managing offers for prepaid telephony accounts, and particularly to facilitating delivery of customized offers to mobile devices of users and real-time activation of such prepaid offers.

A variety of mobile telecommunication services are available to users having prepaid telephony accounts. The services include voice services, messaging services (short messaging service (SMS) and multimedia messaging service (MMS)), data services (browsing services) and value added services, among others. Typically, service providers/mobile operators provide selection from multiple prepaid plans to users while enabling a new prepaid connection. Each user may select a suitable prepaid plan based upon his/her respective usage of the services. In addition, the service provider may also present a variety of prepaid mobile offers to the users from time-to-time. Such offers may be sent to the users via SMS or voice calls.

In general, the prepaid offers available from a service provider include similar offers for all users of the prepaid telephony accounts. As a result, the user may switch to a different service provider if the offers available from another service provider are better than the offers from their current service provider.

Certain service providers track usage data of the users and design and launch personalized price and product offerings to the subscribers based upon such usage data. Such offerings are delivered to the users via various communication tools like SMS or voice calls.

In case a user chooses to accept such offerings, the user follows instructions provided in the SMS or voice call. The instructions may include calling a telephone number, or replying with another SMS message or accessing a WAP site. As a result, the activation of the offers may require substantial time from the point the offer was sent to the user.

Accordingly, it would be desirable to develop methods and systems for managing prepaid offers to enhance customer satisfaction having prepaid telephony accounts.

### BRIEF DESCRIPTION

Briefly, according to one embodiment of the present invention, a method for managing offers for prepaid telephony accounts of a plurality of users is provided. The method includes obtaining information related to user profiles and usage patterns of a plurality of telecommunication services offered to the plurality of users through their respective prepaid telephony accounts. The method also includes customizing prepaid telephony offers for each of the plurality of users based upon the information related to the user profiles and the usage patterns and delivering the customized prepaid telephony offers to a mobile device of each of the plurality of users via unstructured supplementary services data (USSD) messages.

In accordance with another aspect, a system for managing offers for prepaid telephony accounts of a plurality of users is provided. The system includes a host system communicatively coupled to a global system for mobile communications (GSM) cellular network and to mobile devices of each of the plurality of users. The host system is configured to receive information related to user profiles and usage patterns of the plurality of users and to deliver customized prepaid telephony offers in real time to respective mobile device of each of the plurality of users via unstructured supplementary services data (USSD) messages transmitted through the cellular network. The customized offers are delivered to the mobile devices of the users via USSD messages having call charges and balance information sent from a prepaid service control point (SCP) of the cellular network after every successfully charged voice, data and messaging sessions.

In accordance with another aspect, a system for managing offers for prepaid telephony accounts of a plurality of users is provided. The system includes a global system for mobile communications (GSM) cellular network and a host system communicatively coupled to the cellular network and to mobile devices of the plurality of users via an unstructured supplementary services data (USSD) gateway/center. The host system includes an input module configured to receive user profiles and usage patterns of the plurality of users and a database configured to store the user profiles and the usage patterns. The host system also includes a processor configured to analyze the user profiles and the usage patterns and to deliver customized USSD messages having prepaid telephony offers to respective mobile device of each of the plurality of users post each successfully answered call and an activation module configured to activate one or more user selected prepaid telephony offers for each of the plurality of users.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a system for managing offers for prepaid telephony accounts of a plurality of users in accordance with embodiments of the present technique.

FIG. 2 illustrates an embodiment of the host system of FIG. 1. in accordance with embodiments of the present technique.

FIG. 3 is a flow chart illustrating an exemplary method of managing offers for prepaid telephony accounts of users using the system of FIG. 1 in accordance with embodiments of the present technique.

FIG. 4 illustrates exemplary message sequence for receiving and activating customized prepaid offers for a user having a prepaid telephony account in accordance with embodiments of the present technique.

### DETAILED DESCRIPTION

As discussed in detail below, the embodiments of the present invention function to provide a system and method for managing offers for prepaid telephony accounts. In particular, the present technique enables customization of prepaid telephony offers for users with prepaid telephony accounts based upon information such as respective usage details of telecommunication services offered to the users and delivers such customized offers in real time to the mobile devices of the users via unstructured supplementary services data (USSD) messages after every successfully charged voice, data and messaging sessions, or successful recharge of a telephony account of a user. As used herein, the term “real time” refers to a process or action that occurs within a relatively short time.

As will be appreciated by those skilled in the art, USSD provides a text-only, bidirectional, interactive, and session oriented channel of communication between mobile devices and servers in a home public land mobile network (HPLMN) and the visited land public mobile network (VPLMN) of mobile subscribers. USSD is a standard feature of global system for mobile (GSM) and 3^{rd} generation (3G) networks and is originally described in GSM technical specifications 02.90, 03.90 and 04.90.

An exemplary USSD man-machine interface string format is “#SC<data>”, wherein SC stands for the service code and the data field is a text string which may contain any number of characters.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

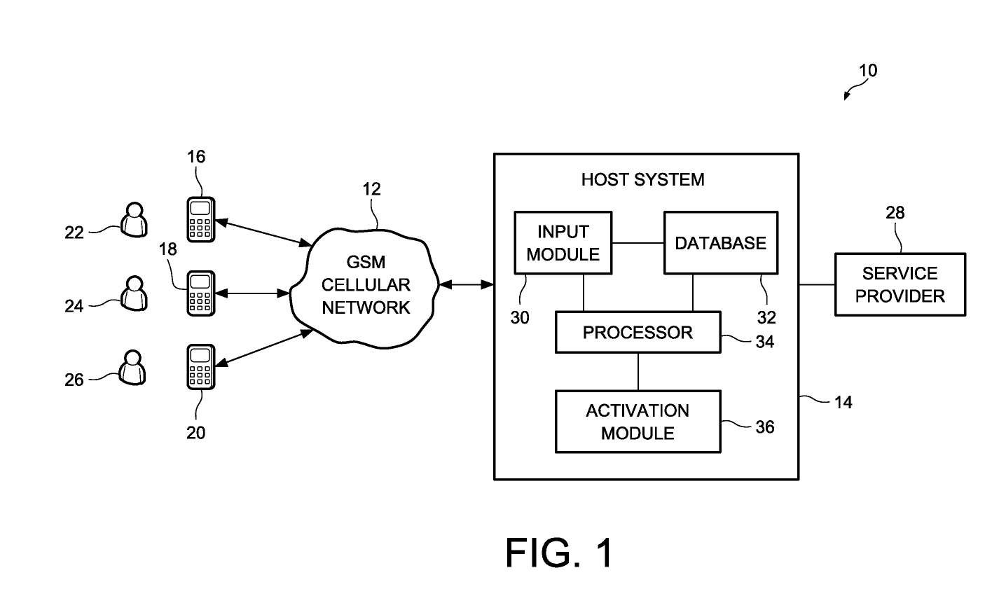

Turning now to drawings and referring first to FIG. 1, a system 10 for managing offers for prepaid telephony accounts of a plurality of users is illustrated. The system 10 includes a mobile network such as a global system for mobile communications (GSM) cellular network 12. The basic operation of the GSM network is well known and, therefore, details related to this system are omitted. A host system 14 is communicatively coupled to the cellular network 12 and to mobile devices such as represented by reference numerals 16, 18 and 20 of a plurality of users such as represented by reference numerals 22, 24 and 26 using prepaid telephony accounts. The host system 14 is further connected to a service provider 28.

In the illustrated embodiment, the host system 14 is configured to receive information related to user profiles and usage patterns of the voice, data and messaging services usage of each of the plurality of users 22, 24 and 26. Further, the host system 14 is configured to deliver customized prepaid telephony offers to respective mobile devices 16, 18 and 20 of the users 22, 24 and 26 via unstructured supplementary services data (USSD) messages. In certain embodiments, the host system 14 is configured to limit the number of prepaid telephony offers sent to a user.

As illustrated, the host system 14 includes an input module 30 configured to receive user profiles and usage patterns of each of the users 22, 24 and 26. The user profiles may include information related to age bands of the users, demographic information of the users, location of the users and the like. In certain embodiments, certain information related to the user profiles may be available with the service provider 28 that may be updated periodically.

Moreover, the usage patterns may include information such as, but not limited to, a burn rate, a total number of calls made by the user, number of local, long distance and international calls made by the user, duration of calls, prepaid recharge patterns (such as amount and frequency of prepaid recharges), number of sent and received messages, internet usage patterns and current balance. As will be appreciated by those skilled in the art, a variety of other usage parameters may be tracked and stored for selecting the offers for the users 22, 24, 26. Such information may be received in real time through the input module 30 and is stored in a database 32. In certain embodiments, the host system 30 is coupled to a home location register (HLR), or a subscriber database, or a prepaid intelligent network, or combinations thereof to obtain the user profiles and the usage patterns of the users 22, 24 and 26.

The host system 30 further includes a processor 34 configured to analyze the user profiles and the usage patterns and to generate customized prepaid offers for each of the users 22, 24 and 26 based upon the information related to the user profiles and the usage patterns. In this embodiment, the processor 34 is configured to select the prepaid offers from a pre-determined set of offers defined by the service provider 28 based upon the user profiles and the usage patterns. Examples of customized prepaid offers include, but are not limited to, preferred rates for voice, data and messaging services, enhanced validity of prepaid telephony accounts and other complimentary services.

In certain embodiments, the customized prepaid offers may be identified for a particular user and eligibility of the user may be determined based upon information related to the user profiles and the usage patterns of the respective user. For example, the processor 34 may analyze the stored user profiles along with usage information such as the types of services the particular user has utilized over a period of time, frequency of usage etc. The selected offers may then be prioritized and sent to the respective user. In certain embodiments, the offers may also include third party communication, or advertisements.

In one exemplary embodiment, the pre-determined set of offers is stored in the database 32 and is updated and maintained by the service provider 28. In certain other embodiments, a separate database/memory device is employed by the service provider 28 to store the offers. In this exemplary embodiment, information related to the user profiles and the usage patterns is acquired and stored in a secure manner and is accessible only to selected users of the system. Such information may not be available to vendors of the service provider 28, for example. The processor 34 is further configured to deliver the customized prepaid offers via USSD messages transmitted to the mobile devices 16, 18 and 20 through the cellular network 12.

In one exemplary embodiment, the customized prepaid offers are included in the USSD message having call charges and balance information typically sent from a prepaid service control point (SCP) of the cellular network 12 after every successfully charged voice, data and messaging sessions and after a successful recharge of a prepaid telephony account. In operation, once a user completed a voice, data or a messaging session, or a recharging session, the host system 14 selects at least one prepaid offer from the pre-determined set of offers and sends a USSD message in a push mode of operation with the last session charges, balance information along with the selected prepaid offer to the mobile phone of the respective user. In one exemplary embodiment, the prepaid offer is selected at least based upon the usage details of the preceding successfully charged voice, data or messaging session. The prepaid offers may include informative or interactive offers.

The host system 14 further includes an activation module 36 configured to activate one or more user-selected prepaid offers for each of the plurality of users 22, 24 and 26. The activation module 36 receives activation requests for activation of one or more prepaid offers from the users 22, 24 and 26 via USSD messages received in a pull mode of operation in response to the messages transmitted in the push mode of operation. The activation module 36 then activates the user-selected offers in real time during the interactive session. In certain embodiments, the activation module may receive a plurality of activation requests from the users 22, 24 and 26 and may activate such offers in a batch mode of operation.

As can be seen, each session described above includes dynamically customizing the prepaid offers for the users 22, 24 and 26, sending these offers in the USSD messages sent to the respective user after each successfully charged call, data session, messaging session and recharging session. In certain embodiments, the technique further includes receiving activation requests for the interactive offers during the same session and dynamically activating such offers.

As will be appreciated by those skilled in the art, a real time session is initiated between the mobile user such as 22, 24 and 26 and the host system 14 when the service is invoked, allowing data to be sent back and forth between the mobile user and the host system 14 until the USSD service (delivering and/or activating customized prepaid offers) is completed.

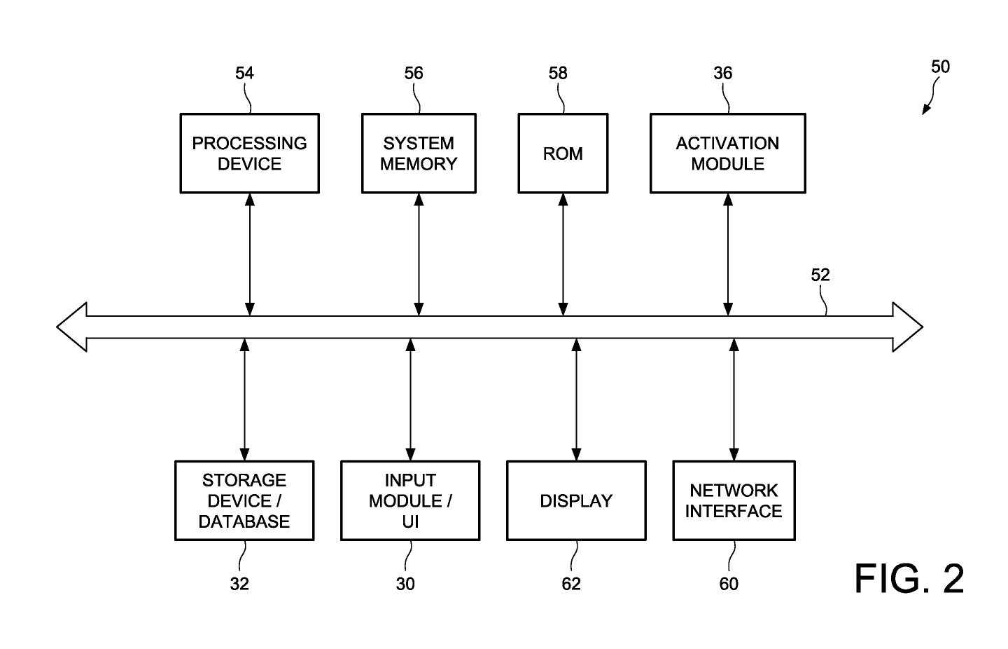

FIG. 2 illustrates an embodiment 50 of the host system 14 of FIG. 1. The host system 50 includes a bus 52 to which the various components are coupled. In certain embodiments, the bus 52 includes a collection of a plurality of buses such as a system bus, a Peripheral Component Interface (PCI) bus, a Small Computer System Interface (SCSI) bus, etc. Representation of these buses as a single bus 52 is provided for ease of illustration, and it should be understood that the host system 50 is not so limited. Those of ordinary skill in the art will appreciate that the host system 50 may have any suitable bus architecture and may include any number of combination of buses.

A processing device 54 is coupled to the bus 52. The processing device 54 may include any suitable processing device or system, including a microprocessor (e.g., a single core or a multi-core processor), a network processor, an application specific integrated circuit (ASIC), or a field programmable gate array (FPGA), or any similar device. It should be noted that although FIG. 2 shows a single processing device 54, the host system 50 may include more processing devices.

The host system 50 further includes system memory 56 coupled to the bus 52. The system memory 56 may include any suitable type and number of memories, such as static random access memory (SRAM), dynamic random access memory (DRAM), synchronous dynamic random access memory (SDRAM), or double data rate DRAM (DDRDRAM). During operation of the host system 50, an operating system and other applications may be resident in the system memory 56.

The host system 50 may further include a read-only memory (ROM) 58 coupled to the bus 52. The ROM 58 may store instructions for the processing device 54. The host system 50 may also include the database/storage device (or devices) 32 coupled to the bus 52. The storage device 32 includes any suitable non-volatile memory, such as, for example, a hard disk drive. Further, devices (not shown) for accessing removable storage media (e.g., a floppy disk drive or a CD ROM drive) may be coupled to the bus 52.

The host system 50 may also include the input module/user interface 30 configured to receive user profiles and usage patterns of the plurality of users 22, 24 and 26 from their respective mobile devices 16, 18 and 20 (see FIG. 1). In the illustrated embodiment, the user interface 30 enables the service provider 28, system administrators and computer programmers to communicate with the host system 50.

In certain embodiments, the user interface 30 may include one or more Input/Output (I/O) devices (not shown) coupled to the bus 52. Common input devices include mobile phone keyboards, pointing devices such as a mouse, as well as other data entry devices. Further, common output devices include video displays, printing devices, and audio output devices. It will be appreciated that these are but a few examples of the types of I/O devices that may be coupled to the bus 52.

The user profiles and usage patterns of the prepaid services for the users are stored in the storage device/database 32 of the host system 50. Moreover, the available prepaid offers from the service provider 28 may also be stored in the storage device/database 32. In certain embodiments, such information may be stored on a secondary storage device (not shown) coupled to the bus 52. In addition, the storage device 32 may be a segmented database stored in multiple locations. The host system 50 may further comprise the activation module 36 configured activate user-selected customized prepaid offers for the respective prepaid telephony accounts of the users.

The host system 50 may further comprise a network interface 60 and a display 62 coupled to the bus 52. The network interface 60 comprises any suitable hardware, software, or combination of hardware and software that is capable of coupling the host system 50 with a network (e.g., a network interface card). The network interface 60 may establish a link with the network over any suitable medium (e.g., wireless, copper wire, fiber optic, or a combination thereof) supporting exchange of information via any suitable protocol such as TCP/IP (Transmission Control protocol/Internet Protocol), HTTP (Hyper-Text Transmission Protocol, as well as others. In particular, the network interface 60 may include components such as a modulator/demodulator (e.g., digital subscriber line, a cable modem), a radio frequency transceiver, a telephonic interface, a router etc.

The host system 50 may employ several types of software such as software for generating customized prepaid offers for the user, software for routing USSD messages between mobile users and service providers, software for monitoring user profiles and usage patterns of the users and software for inserting the prepaid offers in the USSD messages with other information such as the balance and call charges information, call duration, and any combination thereof.

It should be understood that the host system 50 illustrated in FIG. 2 is intended to represent an embodiment of such a system and, further, that this system may include any additional components, which have been omitted for clarity and ease of understanding. Also, it should be understood that the host system 50 may not include all the components shown in FIG. 1.

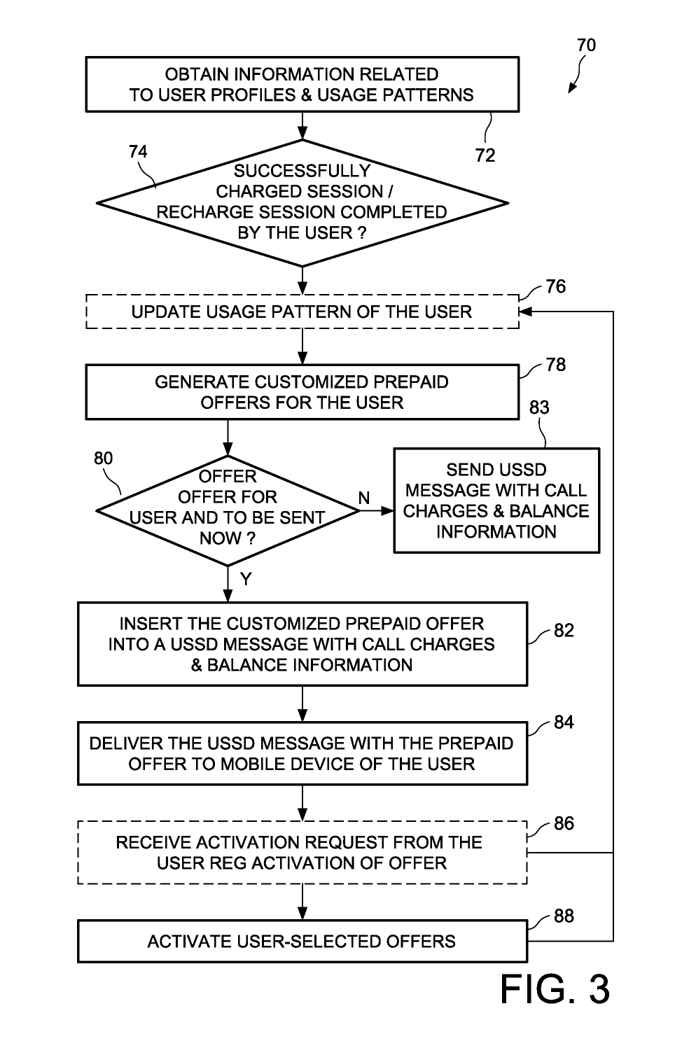

FIG. 3 is a flow chart illustrating an exemplary method 70 of managing offers for prepaid telephony accounts of users using the system 10 of FIG. 1 in accordance with embodiments of the present technique. At block 72, information related to user profiles and usage patterns of a plurality of telecommunication services offered to the users through their respective prepaid telephony accounts is obtained. The telecommunication services offered to the users may include voice services, data services, messaging services, communication delivery such as delivery of advertisements/offers of a third party and combinations thereof.

The user profiles may include information related to age bands of the users, demographic information of the users, location of the users, and the like. Furthermore, the usage patterns may include information such as, but not limited to, a burn rate, a total number of calls made by the user, number of local, long distance and international calls made by the user, duration of calls, prepaid recharge patterns (such as amount and frequency of prepaid recharges), number of sent and received messages, internet usage patterns and current balance. Such information may be dynamically updated and stored by a host system for each of the users.

At block 74, it is verified if a user having the prepaid telephony account has completed a successfully charged session or a recharge session. The charged session may include a voice, data or a messaging session. In certain embodiments, the usage pattern of the user is updated with the usage details of the successfully charged session (block 76). At block 78, customized prepaid offers are generated for the respective user based upon the information related to the user profiles and the usage patterns. In this exemplary embodiment, the customized prepaid offer is generated based at least upon usage details of the preceding charged session. The customized prepaid offers are selected for the user from a pre-determined set of offers available from a telecommunication service provider providing the prepaid telecommunication services. Again, as described before the customized offers may include informative and/or interactive offers.

At block 80, it is verified if there are any customized prepaid offers available based upon the user profile and the usage pattern of the user. It is also determined if an available offer should be delivered to the user now or at a later time. If the prepaid offers are selected to be delivered to the user following the corresponding charged session, the customized prepaid offer is inserted into a USSD message with the session charges, balance and validity information (block 82). If no customized offer is available for the user at that point, then the USSD message with the session charges, call duration, balance and validity information is sent to the user (block 83).

At block 84, the USSD message with the customized prepaid offers and other information such as the last session charges, balance information and so forth is delivered to the user through the cellular network. The USSD message may include informative and/or interactive prepaid offers. The USSD message may be delivered to the respective user in a user-preferred language. In this exemplary embodiment, the USSD message with the prepaid offer includes options for the user regarding activation of one or more customized prepaid offers. At block 86, an activation request for an interactive prepaid offer from the user regarding activation of one or more offers is received. Subsequently, the selected customized prepaid offers are activated for the user. As will be appreciated by one skilled in the art, the users may send the activation request only for selected customized offers.

In the illustrated embodiment, the usage pattern of the respective user is updated on receiving the activation requests and on activation of the user-selected offers (block 76). In certain embodiments, the user-selected offers may not be activated in response to the activation requests due to insufficient funds in the account, or due to a conflicting plan availed by the user, among other reasons. However, the usage pattern is updated based on such activation requests to select suitable offers at a later time.

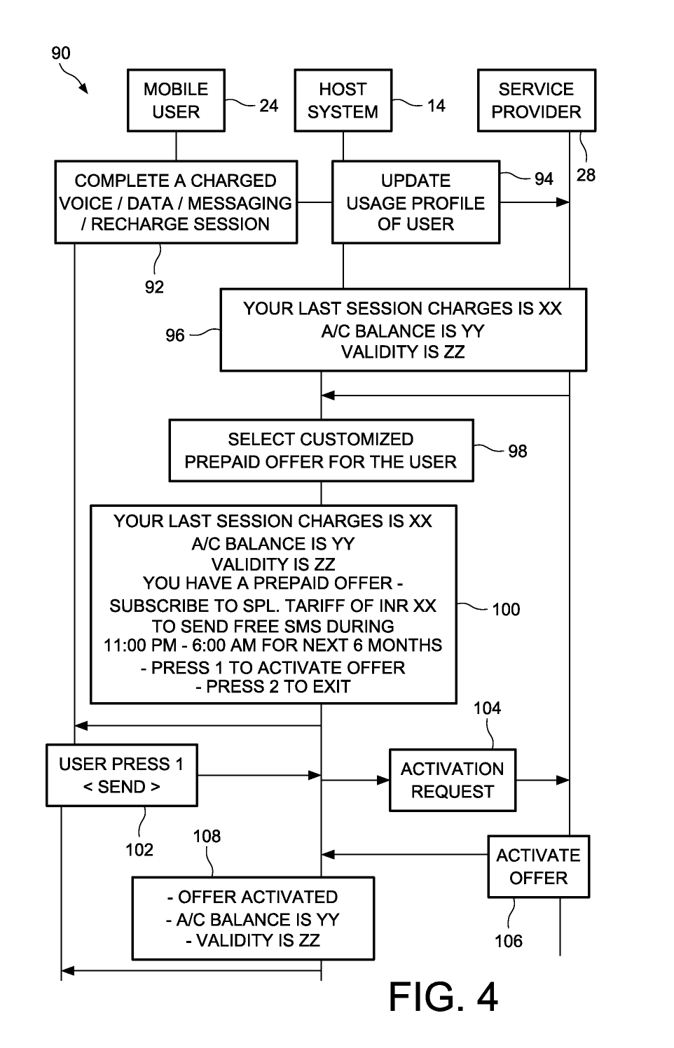

FIG. 4 illustrates exemplary message sequence 90 for receiving and activating customized prepaid offers for a user having a prepaid telephony account. In the illustrated embodiment, the mobile user 24 completes a charged session (voice/data/messaging) session or a recharge session using his/her prepaid telephony account, as represented by reference numeral 92. The host system 14 updates the usage pattern of the user 24 with information related to the completed charged session, as represented by reference numeral 94. The appropriate service provider 28 returns a message 96 to the host system 14 that reports the last session charges, balance information and the validity of the prepaid telephony account.

The host system 14 selects suitable prepaid offers based upon the user profile and the usage pattern of the user, as represented by reference numeral 98. The prepaid offer may be selected from a set of pre-determined offers available from the service provider 28. The pre-determined set of offers may be maintained and updated periodically by the service provider 28. Examples of such prepaid offers may include enhanced validity, preferred rates for the telecommunication services, third party communication or advertisements and so forth. The host system 14 may employ an algorithm to select the relevant offers for each user 24 based upon their respective user profile and prepaid usage patterns.

Once the relevant offer is selected, the host system may customize the USSD message 98 to include the offer. As illustrated, a customized USSD message 100 sent to user 24 may include the details of the last session charges, prepaid account balance information, validity of the account along with the customized offer. For example, the USSD message 100 includes an offer that provides unlimited free messaging services between 11.30 am to 6.00 am for 6 months of period for a special tariff of INR XX. The USSD message 100 may also provide interactive options to the user 24 for activating an offer or to exit the session. In this embodiment, the service provider 28 may deduct the fee for activating the offer such as the special tariff of INR 50 from the users telephony account.

As will be appreciated by those skilled in the art, the customized USSD message 100 may include a variety of prepaid offers defined by the service provider 28. In addition, different options may be provided to the user 24 for activating/de-activating services, recharging the prepaid accounts etc.

It should be noted that the user 24 receives the USSD message 100 with the offer immediately after completing the voice/data/messaging/recharge session. The user 24 may then choose to activate the offer or to exit the session. In the illustrated embodiment, the user 24 selects option 1 in the USSD message 100 to activate the offer, as represented by reference numeral 102. The host system 14 then sends information indicative of activation of the selected offer to the service provider 28 and the selected offer is activated by the service provider, as represented by reference numerals 104 and 106. The host system 14 may subsequently send an USSD message 108 informing the user 24 about the successful activation of the selected offer. In certain embodiments, the service provider 28 may directly send the communication about the activation to the user 24.

As will be those skilled in the art, the USSD message 100 may include more than one customized prepaid offers available to the user 24. The USSD message 100 may also include third party communications such as advertising messages. Moreover, the user 24 may be provided with multiple options for selecting such offers. In certain embodiments, the charges for activating such prepaid offers may be automatically deducted from the available balance of the prepaid telephony account of the user 24 by the host system 14 or the service provider 28. In certain embodiments, the user 24 may choose to exit the session and not avail any of the available customized prepaid offers. In certain other embodiments, the USSD message 100 may provide an option to the user 24 to unsubscribe to such customized offers after each usage session.

As will be appreciated by those of ordinary skill in the art, the foregoing example, demonstrations, and process steps may be implemented by suitable code on a processor-based system. It should also be noted that different implementations of the present technique may perform some or all of the steps described herein in different orders or substantially concurrently, that is, in parallel.

Furthermore, the functions may be implemented in a variety of programming languages, such as C++ or JAVA. Such code, as will be appreciated by those of ordinary skill in the art, may be stored or adapted for storage on one or more tangible, machine readable media, such as on memory chips, local or remote hard disks, optical disks (that is, CD's or DVD's), or other media, which may be accessed by a processor-based system to execute the stored code.

The various aspects of the systems and methods described hereinabove have utility in prepaid telecommunication services. As described above, the technique described above facilitates enables dynamic customization of prepaid offers for user based upon user profiles and prepaid services usage patterns of each user. Further, the technique facilitates delivering such offers via USSD messages sent to mobile devices of the users immediately after completion of a charged session. Advantageously, this technique enables real-time delivery of the prepaid offers along with immediate activation of user-selected options using USSD messages.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for managing offers for prepaid telephony accounts of a plurality of users, the method comprising:
obtaining information related to user profiles and usage patterns of a plurality of telecommunication services offered to the plurality of users through their respective prepaid telephony accounts;
customizing prepaid telephony offers for each of the plurality of users based upon the information related to the user profiles and the usage patterns; and
delivering the customized prepaid telephony offers to a mobile device of each of the plurality of users via unstructured supplementary services data (USSD) messages.

2. The method of claim 1, wherein the USSD messages are delivered through a global system for mobile communications (GSM) cellular network.

3. The method of claim 1, wherein delivering the customized prepaid telephony offers to the mobile device of each user comprises customizing the USSD message sent to the respective user post a successfully charged session, wherein the customized USSD message comprises the customized prepaid offer along with last call charges and balance information sent from a prepaid service control point (SCP) immediately after at least one of a voice session, data session, a messaging session and a recharge session.

4. The method of claim 3, wherein customizing the prepaid telephony offers comprises customizing the offer based at least upon usage details of a preceding voice, data, or messaging session.

5. The method of claim 1, further comprising receiving an activation request regarding activation of one or more customized prepaid telephony offers from the mobile device of one or more users via a USSD message in response to the delivered customized prepaid offers.

6. The method of claim 5, further comprising activating the one or more customized prepaid telephony offers for a respective user in response to the received activation request.

7. The method of claim 1, wherein the user profiles comprise information related to age bands of the users, demographic information of the users, location of the users, a time of usage, or combinations thereof.

8. The method of claim 1, wherein the plurality of telecommunication services comprise voice services, data services, messaging services, or combinations thereof.

9. The method of claim 1, wherein the usage patterns comprise information related to a burn rate, a total number of calls, number of local calls, number of long distance calls, number of international calls, duration of calls, prepaid recharge patterns, number of sent and received messages, internet usage patterns, current balance, or combinations thereof.

10. The method of claim 1, wherein customizing the prepaid telephony offers comprises selecting offers for each user from a pre-determined set of offers defined by a telecommunication provider providing the plurality of telecommunication services.

11. The method of claim 10, further comprising limiting a number of the prepaid telephony offers offered to each of the plurality of users.

12. The method of claim 1, wherein the customized prepaid telephone offers include preferred rates for the telecommunication services, enhanced validity of telephony accounts, complimentary telecommunication services, or third party advertisements, or combinations thereof.

13. A system for managing offers for prepaid telephony accounts of a plurality of users, the system comprising:
a host system communicatively coupled to a global system for mobile communications (GSM) cellular network and to mobile devices of each of the plurality of users, wherein the host system is configured to receive information related to user profiles and usage patterns of the plurality of users and to deliver customized prepaid telephony offers in real time to respective mobile device of each of the plurality of users via unstructured supplementary services data (USSD) messages transmitted through the cellular network and wherein the customized offers are delivered to the mobile devices of the users via USSD messages having call charges and balance information sent from a prepaid service control point (SCP) of the cellular network after every successfully charged voice, data and messaging sessions.

14. The system of claim 13, wherein the host system comprises a database configured to store information regarding the user profiles and the usage patterns of the plurality of users.

15. The system of claim 14, wherein the database is further configured to store a plurality of prepaid telephony offers generated by the host system.

16. The system of claim 13, wherein the host system comprises a processor configured to analyze the user profiles and the usage patterns of the plurality of users and to dynamically generate the customized prepaid telephony offers based upon the user profiles and the usage patterns.

17. The system of claim 13, wherein the processor is configured to send the customized prepaid telephony offers to the mobile devices of the users via USSD messages transmitted in a push mode of operation and to receive activation requests for activation of one or more offers from the users via USSD message received in a pull mode of operation in response to the messages transmitted in the push mode of operation.

18. The system of claim 17, wherein the host system is configured to activate the one or more customized prepaid telephony offers for each of the plurality of users in response to the corresponding received activation responses.

19. The system of claim 13, wherein the user profiles comprise information related to age bands of the users, demographic information of the users, location of the users, a time of usage, or combinations thereof.

20. The system of claim 13, wherein the usage profiles comprise information related to a burn rate, a total number of calls, number of local calls, number of long distance calls, number of international calls, duration of calls, prepaid recharge patterns, number of sent and received messages, internet usage patterns, or combinations thereof.

21. The system of claim 13, wherein the customized prepaid telephone offers include preferred rates for the telecommunication services, enhanced validity of telephony accounts, complimentary telecommunication services, or combinations thereof.

22. A system for managing offers for prepaid telephony accounts of a plurality of users, the system comprising:
a global system for mobile communications (GSM) cellular network;
a host system communicatively coupled to the cellular network and to mobile devices of the plurality of users via an unstructured supplementary services data (USSD) gateway/center, wherein the host system comprises:
an input module configured to receive user profiles and usage patterns of the plurality of users;
a database configured to store the user profiles and the usage patterns;
a processor configured to analyze the user profiles and the usage patterns and to deliver customized USSD messages having prepaid telephony offers to respective mobile device of each of the plurality of users post each successfully answered call; and
an activation module configured to activate one or more user-selected prepaid telephony offers for each of the plurality of users.

23. The system of claim 22, wherein the processor is configured to select the prepaid telephony offers from a pre-determined set of offers defined by an operator of the host system and wherein the USSD messages with the offers are delivered in a user-selected language.

24. The system of claim 22, wherein the processor is configured to select a number of and timing of sending the prepaid telephony offers and third party communications to the mobile devices of the users.

25. The system of claim 22, wherein the host system is coupled to a home location register (HLR), or a subscriber database, or a prepaid intelligent network or combinations thereof of the cellular network to obtain the user profiles and the usage patterns of the plurality of users.
